(19) United States
(12) Patent Application Publication
(10) Pub. No.: US 2014/0115550 A1
(43) Pub. Date: Apr. 24, 2014

(54) COMPUTING DEVICE AND METHOD FOR CHECKING LENGTH OF SIGNAL TRACE

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: YA-LING HUANG, Shenzhen (CN); CHIA-NAN PAI, Tu-Cheng (TW); SHOU-KUO HSU, Tu-Cheng (TW)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/014,465

(22) Filed: Aug. 30, 2013

(30) Foreign Application Priority Data
Oct. 18, 2012 (CN) 2012103966664

(51) Int. Cl. G06F 17/50

(52) U.S. Cl. CPC G06F 17/5081
USPC 716/112

(57) ABSTRACT

In a method for checking the length of a signal trace between a coupling capacitor and a via in a printed circuit board (PCB) design using a computing device, a PCB file is obtained from a storage device to simulate a PCB design. The signal trace between the coupling capacitor and the via is filtered on the PCB design, and a real length of the signal trace between the coupling capacitor and the via is calculated. If the real length is greater than a specified length, the method locates a position of the via on the PCB design and generates a design report indicating that the signal trace between the coupling capacitor and the via is unqualified. The method further displays information of the signal trace on a display device of the computing device.

### BACKGROUND

1. Technical Field

Embodiments of the present disclosure relate to a printed circuit board (PCB) layout systems and methods, and particularly to a computing device and a method for checking a length of a signal trace between a capacitor and a via in a PCB design.

2. Description of Related Art

PCBs mechanically support and electronically interconnect electronic components using conductive pathways, traces, or etched copper sheets laminated onto a non-conductive substrate. Some PCBs have multiple layers and are called multilayer PCBs. The multilayer PCBs are composed of between one and twenty-four conductive layers separated and supported by layers of insulating material (substrates) laminated (glued with heat, pressure or vacuum) together. Every two adjacent layers may be connected together through a drilled hole, which is generally called a via.

The use of vias introduces equivalent series inductance (ESL), which leads to low-frequency power supply noise and high-frequency electromagnetic interference. Hence, it is very important to control the area of the electric current loop by means of checking a signal trace between a capacitor and a via of a PCB design. It is generally difficult, laborious, and time-consuming to check the length manually. What is needed, therefore, is a system and method which can check the length of a signal trace between a capacitor and a via of the PCB design, for the sake of reducing labor intensity and enhancing work efficiency.

### BRIEF DESCRIPTION OF THE DRAWINGS

FIG. 1 is a block diagram of one embodiment of a computing device including a signal trace checking system.

FIG. 2 is a flowchart of one embodiment of a method for checking a length of a signal trace between a coupling capacitor and a via in a PCB design using the computing device of FIG. 1.

FIG. 3 shows one embodiment of a PCB design simulated according to a PCB file.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

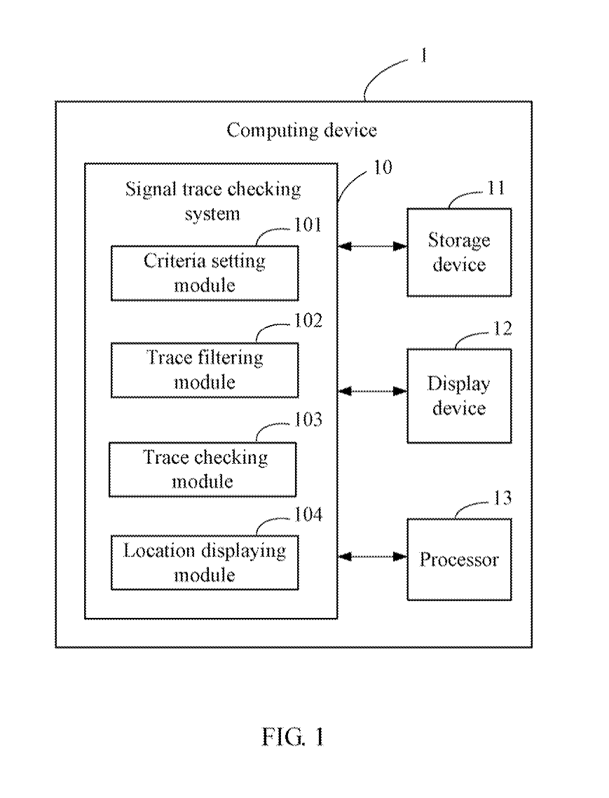

FIG. 1 is a block diagram of one embodiment of a computing device 1 including a signal trace checking system 10. In the embodiment, the signal trace checking system 10 is implemented by the computing device 1, checks the length of a signal trace between a coupling capacitor and a via in a printed circuit board (PCB) design, and determines whether the signal trace of the PCB design is acceptable based on the checked length. The computing device 1 further includes, but is not limited to, a storage device 11, a display device 12, and at least one processor 13. In one embodiment, the computing device 1 may be a personal computer (PC), a server, or any other data processing device.

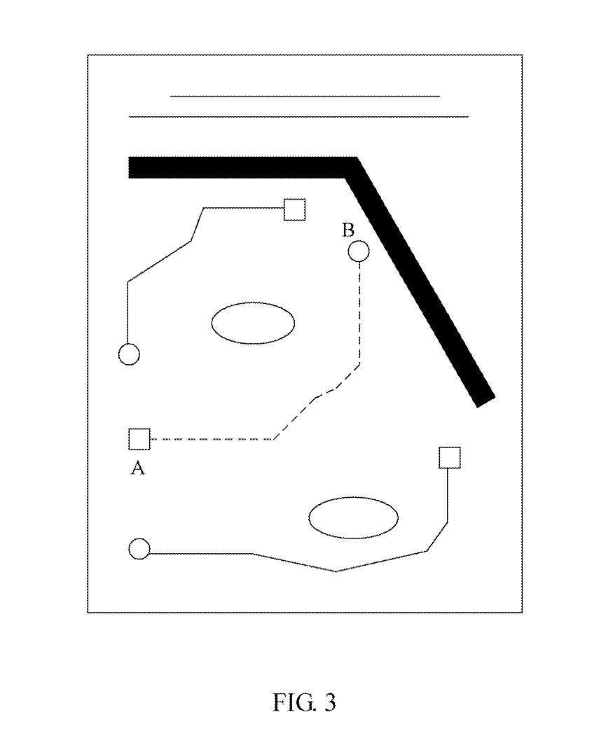

The storage device 11 stores one or more PCB files, and each of the PCB files can simulate a PCB design. FIG. 3 shows one embodiment of a PCB design simulated according to a PCB file stored in the storage device 11. The PCB design may include a plurality of signal traces, coupling capacitors and vias. The signal traces are used to connect the coupling capacitors to the vias. The box A denotes a coupling capacitor, and the circle B denotes a via. The wire AB denotes a signal trace between the coupling capacitor A and the via B.

In one embodiment, the storage device 11 may be an internal storage system, such as a random access memory (RAM) for temporary storage of information, and/or a read only memory (ROM) for permanent storage of information. The storage device 11 may also be an external storage system, such as an external hard disk, a storage card, network access storage (NAS), or a data storage medium. The at least one processor 13 is a central processing unit (CPU) or microprocessor that performs various functions of the computing device 1.

In one embodiment, the signal trace checking system 10 includes a criteria setting module 101, a trace filtering module 102, a trace checking module 103, and a location displaying module 104. The modules 101-104 may comprise computerized instructions in the form of one or more computer-readable programs that are stored in a non-transitory computer-readable medium (such as the storage device 11) and executed by the at least one processor 13.

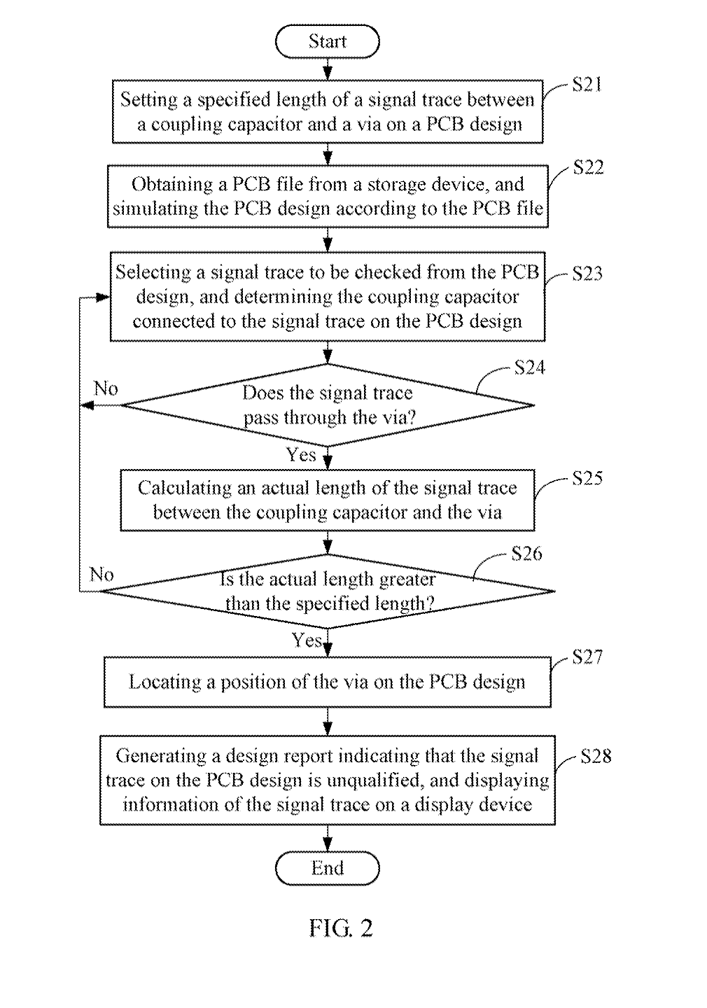

A description of each module is given in the following paragraphs. FIG. 2 is a flowchart of one embodiment of a method for checking a length of a signal trace between a coupling capacitor and a via in a PCB design using the computing device 1 of FIG. 1. The method is performed by execution of computer-readable program codes or instructions stored in the storage device 11 and executed by the at least one processor 12.

Depending on the embodiment, additional steps may be added, others removed, and the ordering of the steps may be changed.

In step S21, the criteria setting module 101 sets a specified length of the signal trace between a coupling capacitor and a via of the PCB design. In the embodiment, the specified length of the signal trace is a standard length complying with a PCB design specification. For example, the PCB design specification specifies the length of a signal trace between each coupling capacitor and each via on the PCB design as being 300 mils.

In step S22, the trace filtering module 102 obtains a PCB file from the storage device 11, and simulates a PCB design according to the PCB file. In the embodiment, the PCB file may include layout information of the PCB design, such as information on capacitors, vias and a length of a signal trace between each capacitor and each via of the PCB design. Referring to FIG. 3, a PCB design is simulated according to a PCB file that is stored in the storage device 11. The PCB design may include a plurality of signal traces, coupling capacitors and vias. Each signal trace is used to connect the coupling capacitors to the vias of the PCB design.

In step S23, the trace filtering module 102 filters the signal trace between a coupling capacitor and a via on the PCB design. In the embodiment, the signal trace is filtrated on the PCB design by performing steps of: selecting a signal trace to be checked from the PCB design, determining whether the coupling capacitor is connected to the signal trace on the PCB design, and determining whether the signal trace passes through the via on the PCB design.

In step S24, the trace filtering module 102 determines whether the signal trace passes through a via on the PCB design. Referring to FIG. 3, the box A denotes a coupling capacitor, and the circle B denotes a via. The wire AB denotes a signal trace between the coupling capacitor A and the via B. If the signal trace passes through a via on the PCB design, step S25 is implemented. Otherwise, if the signal trace does not pass through a via on the PCB design, the process goes back to step S23.

In step S25, the trace checking module 103 calculates a real length of the signal trace between the coupling capacitor and the via on the PCB design. In one embodiment, the real length of the signal trace is calculated by adding each section line between the coupling capacitor and the via on the PCB design.

In step S26, the trace checking module 103 checks whether the real length is greater than the specified length, such as 300 mil. If the real length is greater than the specified length, step S27 is implemented. Otherwise, if the real length is not greater than the specified length, the process goes back to step S23.

In step S27, the location displaying module 104 locates a position of the via on the PCB design, and marks the signal trace between the coupling capacitor and the via on the PCB design. In one embodiment, the signal trace between the coupling capacitor and the via may be marked on the PCB design by a colored circle or a colored line.

In step S28, the location displaying module 104 generates a design report for the designer indicating that the signal trace of the PCB design is unqualified, and displays information of the signal trace between the coupling capacitor and the via on the display device 12. In the embodiment, the information of the signal trace may include a serial number of the signal trace, a name of the coupling capacitor, the position of the via on the PCB design, and the real length of the signal trace between the coupling capacitor and the via on the PCB design.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
at least one processor; and
a storage device storing a computer-readable program including instructions that, which when executed by the at least one processor, causes the at least one processor to:
obtain a printed circuit board (PCB) file from the storage device, and simulate a PCB design according to the PCB file;
filter a signal trace between a coupling capacitor and a via on the PCB design;
calculate a real length of the signal trace between the coupling capacitor and the via on the PCB design;
determine whether the real length is greater than a specified length of the signal trace between the coupling capacitor and the via on the PCB design;
locate a position of the via on the PCB design when the real length is greater than the specified length; and
generate a design report indicating that the signal trace between the coupling capacitor and the via on the PCB design is unqualified, and display information of the signal trace between the coupling capacitor and the via on a display device of the computing device.

2. The computing device according to claim 1, wherein the signal trace between the coupling capacitor and the via is filtered on the PCB design by performing steps of:
selecting a signal trace to be checked from the PCB design;
determining whether the coupling capacitor is connected to the signal trace on the PCB design; and
determining whether the signal trace passes through the via on the PCB design.

3. The computing device according to claim 1, wherein the specified length of the signal trace between the coupling capacitor and the via is set according to a PCB design specification.

4. The computing device according to claim 1, wherein the real length of the signal trace is calculated by adding each section line between the coupling capacitor and the via on the PCB design.

5. The computing device according to claim 1, wherein the computer-readable program further causes the at least one processor to mark the signal trace between the coupling capacitor and the via on the PCB when the position of the via is located on the PCB design.

6. The computing device according to claim 1, wherein the information of the signal trace comprises a serial number of the signal trace, a name of the coupling capacitor, the position of the via on the PCB design, and the real length of the signal trace between the coupling capacitor and the via on the PCB design.

7. A computerized method for checking a length of a signal trace using a computing device, the method comprising:
obtaining a printed circuit board (PCB) file from a storage device of the computing device, and simulating a PCB design according to the PCB file;
filtering a signal trace between a coupling capacitor and a via on the PCB design;
calculating a real length of the signal trace between the coupling capacitor and the via on the PCB design;
determining whether the real length is greater than a specified length of the signal trace between the coupling capacitor and the via on the PCB design;
locating a position of the via on the PCB when the real length is greater than the specified length; and
generating a design report indicating that the signal trace between the coupling capacitor and the via on the PCB design is unqualified, and displaying information of the signal trace between the coupling capacitor and the via on a display device of the computing device.

8. The method according to claim 7, wherein the signal trace between the coupling capacitor and the via is filtered on the PCB design by performing steps of:
selecting a signal trace to be checked from the PCB design;
determining whether the coupling capacitor is connected to the signal trace on the PCB design; and
determining whether the signal trace passes through the via on the PCB design.

9. The method according to claim 7, wherein the specified length of the signal trace between the coupling capacitor and the via is set according to a PCB design specification.

10. The method according to claim 7, wherein the real length of the signal trace is calculated by adding each section line between the coupling capacitor and the via on the PCB design.

11. The method according to claim 7, further comprising:
marking the signal trace between the coupling capacitor and the via on the PCB design when the position of the via is located on the PCB design.

12. The method according to claim 7, wherein the information of the signal trace comprises a serial number of the signal trace, a name of the coupling capacitor, the position of the via on the PCB, and the real length of the signal trace between the coupling capacitor and the via on the PCB design.

13. A non-transitory storage medium having stored thereon instructions that, when executed by at least one processor of a computing device, cause the processor to perform a method for checking a length of a signal trace, the method comprising:
obtaining a printed circuit board (PCB) file from a storage device of the computing device, and simulating a PCB design according to the PCB file;
filtering a signal trace between a coupling capacitor and a via on the PCB design;
calculating a real length of the signal trace between the coupling capacitor and the via on the PCB design;
determining whether the real length is greater than a specified length of the signal trace between the coupling capacitor and the via on the PCB design;
locating a position of the via on the PCB design when the real length is greater than the specified length; and
generating a design report indicating that the signal trace between the coupling capacitor and the via on the PCB design is unqualified, and displaying information of the signal trace between the coupling capacitor and the via on a display device of the computing device.

14. The storage medium according to claim 13, wherein the signal trace between the coupling capacitor and the via is filtered on the PCB design by performing steps of:
selecting a signal trace to be checked from the PCB design;
determining whether the coupling capacitor is connected to the signal trace on the PCB design; and
determining whether the signal trace passes through the via on the PCB design.

15. The storage medium according to claim 13, wherein the specified length of the signal trace between the coupling capacitor and the via is set according to a PCB design specification.

16. The storage medium according to claim 13, wherein the real length of the signal trace is calculated by adding each section line between the coupling capacitor and the via on the PCB design.

17. The storage medium according to claim 13, wherein the method further comprises:
marking the signal trace between the coupling capacitor and the via on the PCB design when the position of the via is located on the PCB design.

18. The storage medium according to claim 13, wherein the information of the signal trace comprises a serial number of the signal trace, a name of the coupling capacitor, the position of the via on the PCB design, and the real length of the signal trace between the coupling capacitor and the via on the PCB design.
